(19) United States
(12) Patent Application Publication
(10) Pub. No.: US 2011/0078730 A1
(43) Pub. Date: Mar. 31, 2011

(54) METHOD AND APPARATUS FOR SCHEDULING RADIO ACCESS TO REDUCE CHANNEL ZAPPING DELAY

(75) Inventors: Jee Hyeon NA, Daejeon (KR); Jung Mo MOON, Daejeon (KR); Jai Hyung CHO, Daejeon (KR); Sang Ho LEE, Daejeon (KR); Jae Heung KIM, Daejeon (KR); Soon Gi PARK, Daejeon (KR); Changki KIM, Daejeon (KR); Yeon Seung SHIN, Daejeon (KR)

(73) Assignee: Electronics and Telecommunications Research Institute, Daejeon (KR)

(21) Appl. No.: 12/852,927

(22) Filed: Aug. 9, 2010

(30) Foreign Application Priority Data
Sep. 28, 2009 (KR) 10-2009-0091662

(51) Int. Cl. G06F 13/00; H04N 9/64; H04N 7/173

(52) U.S. Cl. 725/38; 348/720; 348/E09.037; 348/E05.097

(57) ABSTRACT

Provided is a method and apparatus for scheduling a radio access to reduce a channel zapping delay. The radio access scheduling method may receive abstract information with respect to all of currently receivable channels at each channel scheduling interval, and may receive the abstract information in advance and provide the abstract information when a channel change request is received, and thereby reduce the channel zapping delay.

### CROSS-REFERENCE TO RELATED APPLICATION

This application claims the benefit of Korean Patent Application No. 10-2009-0091662, filed on Sep. 28, 2009, in the Korean Intellectual Property Office, the disclosure of which is incorporated herein by reference.

### BACKGROUND

1. Field of the Invention

Embodiments of the present invention relate to a method and apparatus for scheduling a radio access to reduce a channel zapping delay when providing a broadcasting service in a mobile communication system.

2. Description of the Related Art

In comparison to an analog television (TV) service, a digital TV service and a mobile TV service may need a longer period of time to change a channel. A channel zapping delay may occur due to characteristics of I, B, and P frames used to enhance a compression rate in a Motion Picture Experts Groups (MPEG) compression scheme. For example, due to characteristics of the MPEG compression scheme, a black screen may be displayed until the I frame of the changed channel is read.

The channel zapping delay occurring in a mobile TV may include a time used to retrieve the I frame and may also include a time used until service data of a channel changed according to scheduling of radio resources in a radio access interval is received.

Accordingly, there is a need for research that may reduce a channel zapping delay when providing a broadcasting service in a mobile communication system.

### SUMMARY

An aspect of the present invention provides a method and apparatus for scheduling a random access to reduce a channel zapping delay that may receive abstract information with respect to all currently receivable channels, and may receive the abstract information in advance to provide the abstract information when a channel change request is received.

Another aspect of the present invention also provides a method and apparatus for scheduling a random access to reduce a channel zapping delay that may receive abstract information with respect to all currently receivable channels, and then may extract the abstract information at each channel scheduling interval or for each channel change request, and provide the extracted abstract information when a channel change request is received, and thereby may enable a power saving in a terminal and reduce a channel zapping delay.

According to an aspect of the present invention, there is provided a method of scheduling a radio access to reduce a channel zapping delay, the method including: receiving abstract information with respect to all of receivable channels at each channel scheduling interval; and providing information associated with a channel to be changed to using the abstract information during the channel zapping delay when a channel change request is received.

The abstract information may be provided after a scheduling block containing scheduling information associated with a plurality of channels and be provided using an independent channel, or may be included in the scheduling block and thereby be provided.

The abstract information may be provided at a predetermined location using an independent channel. Information associated with at least one of a size and a location of the independent channel may be included in a scheduling block containing scheduling information associated with a plurality of channels that is included in a corresponding scheduling interval, and thereby be provided.

The abstract information may be provided within an independent information field. The providing may include extracting the abstract information by accessing an address of the independent information field, and providing information associated with the channel to be changed to using the extracted abstract information.

The providing may include extracting the received abstract information every time schedule information associated with a plurality of channels is extracted.

The providing may include extracting the received abstract information when the channel change request is received.

The abstract information may include at least one of a character, an audio, a picture, and a moving picture with respect to each of all the receivable channels.

According to another aspect of the present invention, there is provided a method of scheduling a radio access to reduce a channel zapping delay, the method including: setting an independent channel containing abstract information with respect to all currently receivable channels; and adding the independent channel to be after a scheduling block containing scheduling information associated with a plurality of channels to transmit the scheduling information at each channel scheduling interval.

According to still another aspect of the present invention, there is provided an apparatus for scheduling a radio access to reduce a channel zapping delay, the apparatus including: a data receiver to receive abstract information with respect to all of receivable channels at each channel scheduling interval; and a delay compensation unit to provide information associated with a channel to be changed to using the abstract information during the channel zapping delay when a channel change request is received.

### EFFECT

According to embodiments of the present invention, there may be provided a method and apparatus for scheduling a random access to reduce a channel zapping delay that may receive abstract information with respect to all currently receivable channels, and may receive the abstract information in advance to provide the abstract information when a channel change request is received.

Also, according to embodiments of the present invention, there may be provided a method and apparatus for scheduling a random access to reduce a channel zapping delay that may receive abstract information with respect to all currently receivable channels, and then may extract the abstract information at each channel scheduling interval or for each channel change request, and provide the extracted abstract information when a channel change request is received, and thereby may enable a power saving in a terminal and reduce a channel zapping delay.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of scheduling a radio access to reduce a channel zapping delay according to an embodiment of the present invention;

FIG. 2 is a diagram illustrating a process of transmitting abstract information after a scheduling block according to an embodiment of the present invention;

FIG. 3 is a diagram illustrating a process of providing abstract information when a channel change request is received according to an embodiment of the present invention;

FIG. 4 is a diagram illustrating a process of providing abstract information when a channel change request is received according to another embodiment of the present invention;

FIG. 5 is a flowchart illustrating a method of scheduling a radio access to reduce a channel zapping delay according to another embodiment of the present invention; and

FIG. 6 is a block diagram illustrating an apparatus for scheduling a radio access to reduce a channel zapping delay according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

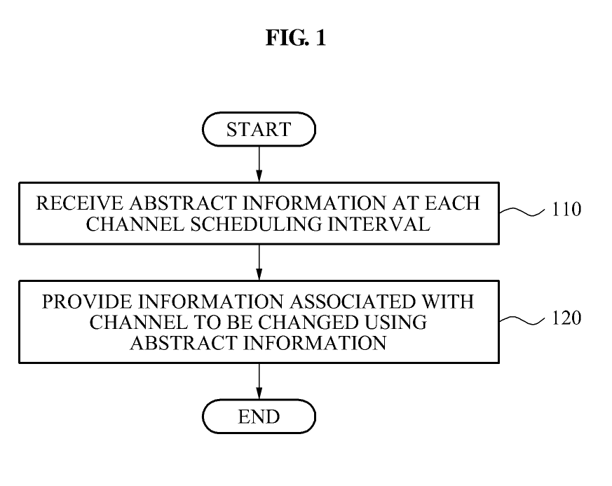

FIG. 1 is a flowchart illustrating a method of scheduling a radio access to reduce a channel zapping delay according to an embodiment of the present invention.

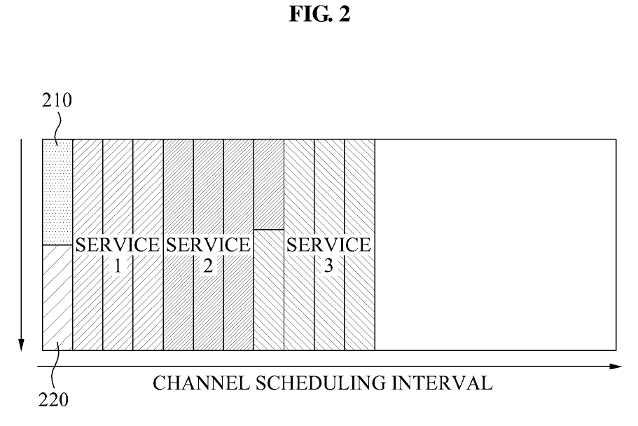

In operation 110, abstract information may be received with respect to all receivable channels at each channel scheduling interval. The abstract information may be provided after a scheduling block using an independent channel, or may be included in the scheduling block and thereby be provided. A terminal may receive the abstract information at each channel scheduling interval. Here, the scheduling block denotes a block that includes scheduling information associated with a plurality of channels, and may be provided at each channel scheduling interval. Hereinafter, a process of receiving the abstract information will be further described with reference to FIG. 2.

FIG. 2 is a diagram illustrating a process of transmitting abstract information after a scheduling block according to an embodiment of the present invention.

FIG. 2 shows a scheduling scheme with respect to services included in a single channel scheduling interval for a broadcasting service between a terminal and a base station in a mobile communication network. For dynamic scheduling, a scheduling block 210 that contains dynamic scheduling information associated with services included in each channel scheduling interval may exist in each channel scheduling interval. The scheduling block 210 may include scheduling information associated with services allocated to a corresponding channel scheduling interval.

Abstract information with respect to all currently receivable channels may be provided after the scheduling block 210 using a separate channel. For example, the abstract information may be provided to be at a fixed location after the scheduling block 210 using “SERVICE 0” 220 that is a separate independent channel type. Here, “SERVICE 0” may indicate a service that includes the abstract information with respect to all the channels being broadcasted, and may be provided in various forms, for example, a single still cut screen, an audio, a low resolution image, and a single-lined text with respect to each of the channels being broadcasted. “SERVICE 0” may be read together when scheduling block information is read. Therefore, it is possible to maintain a power saving effect of services scheduled for power saving.

Although the location of “SERVICE 0” is fixed to be after the scheduling block 210 in FIG. 2, “SERVICE 0” may be fixed to be at another location instead of after the scheduling block 210, and thereby be provided. In this instance, information associated with a size, a location, and the like of the independent channel may be included in the scheduling block 210 containing the scheduling information associated with a plurality of channels that is included in a channel scheduling interval, and thereby be provided.

Also, the abstract information may be included in the scheduling block 210 and thereby be provided, instead of being provided in a separate channel form. Accordingly, the abstract information may be extracted by reading the scheduling block 210.

The abstract information may be provided in a form of an information field defined in a system, instead of being provided in the separate channel form. The abstract information included in the information field may be addressed using control information so that the terminal may receive the abstract information.

Referring again to FIG. 1, in operation 120, when a channel change request is received, information associated with a channel to be changed to may be provided using the abstract information during a channel zapping delay. When the channel change request is received from a user, the channel zapping delay may occur. An amount of the channel zapping delay corresponds to an amount of time that is obtained by adding up an amount of time used to search for an I frame of the channel to be changed to and an amount of time used to receive service data of the channel to be changed to. Therefore, the abstract information associated with the channel to be changed to may be provided during the channel zapping delay. During the channel zapping delay, the user may view at least one of a character, an audio, a still cut, and a moving picture of the channel to be changed to, instead of viewing a black screen that does not provide a service. Accordingly, the user may not feel the channel zapping delay.

Here, a terminal may extract the abstract information at each channel scheduling interval, or may extract the abstract information when the channel change request is received from the user. In a case where the terminal extracts the abstract information at each channel scheduling interval, it may be possible to provide the extracted abstract information immediately after the channel change request is received from the user. However, resources may be used to extract the abstract information. In a case where the terminal extracts the abstract information when the channel change request is received from the user, it may be possible to save resources. However, it may be impossible to provide the extracted information immediately after the channel change request is received from the user. Specifically, instead of providing the extracted information at the same time when the channel change request is received, the abstract information may be extracted in a subsequent channel scheduling interval and be provided.

As described above, by receiving the abstract information and providing the received abstract information when the channel change request is received from the user, the user may feel as though a service is being continuously provided without the channel zapping delay.

Also, the user may set the abstract information to be extracted at each channel scheduling interval or when the channel change request is received. Accordingly, it is possible to maintain a power saving effect and reduce a channel zapping delay.

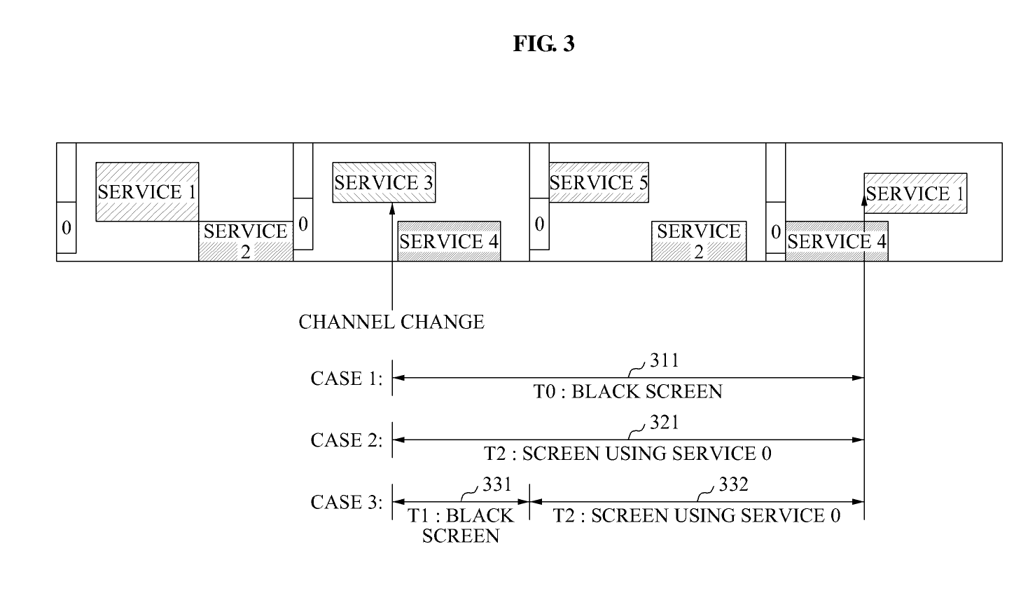

FIG. 3 is a diagram illustrating a process of providing abstract information when a channel change request is received according to an embodiment of the present invention.

When a terminal receiving a broadcasting service desires to change a channel, a channel zapping delay may occur during a period of time from a point in time when a channel change request is received, to a point in time when the channel is changed. Referring to FIG. 3, in a case where the terminal requests a channel change to change a current channel of SERVICE 3 to a channel of SERVICE 1, CASE 1 may provide a black screen during a channel zapping delay 311 according to a related art.

According to the present invention, in CASE 2, abstract information received using “SERVICE 0” that is a separate channel may be extracted at each channel scheduling interval. The abstract information associated with the channel to be changed to may be received in advance using “SERVICE 0” and provided during a period of time 321 from when the channel change request is received to when the channel change is completed.

According to the present invention, in CASE 3 where abstract information is extracted when the channel change request is received instead of extracting the abstract information at each channel scheduling interval, the abstract information may be extracted in a subsequent channel scheduling interval, and may be provided during a period of time from when the extraction of the abstract information is completed to when the channel change is completed. Specifically, a black screen may be provided during a period of time 331 from when the channel change request is received to when “SERVICE 0” of a subsequent scheduling block is read. Abstract information associated with the channel to be changed to may be provided using “SERVICE 0” during a period of time 332 from when “SERVICE 0” is read to when the channel change is completed.

Here, “SERVICE 0” may include a character, an audio, a still cut, a moving picture, and the like. When the character is included in “SERVICE 0”, information transmission may be focused on. When at least one of the audio and the still cut is included in “SERVICE 0”, a change of a screen may occur, and the audio and the still cut may be more useful than a low quality of the moving picture. Also, when the audio and the low quality of the moving picture are included in “SERVICE 0”, the user may feel as though a service is being continuously provided.

Various types of contents may be included in “SERVICE 0” based on a data rate of services being scheduled. For example, it is possible to generate data to be included in the abstract information at various data rates. Also, it is possible to enhance a resource utilization and to decrease a channel zapping delay by allocating a resource for “SERVICE 0” based on services currently being provided and remaining radio resources, and by selecting an appropriate data rate based on the resource for “SERVICE 0” to transmit data to a terminal at the selected data rate.

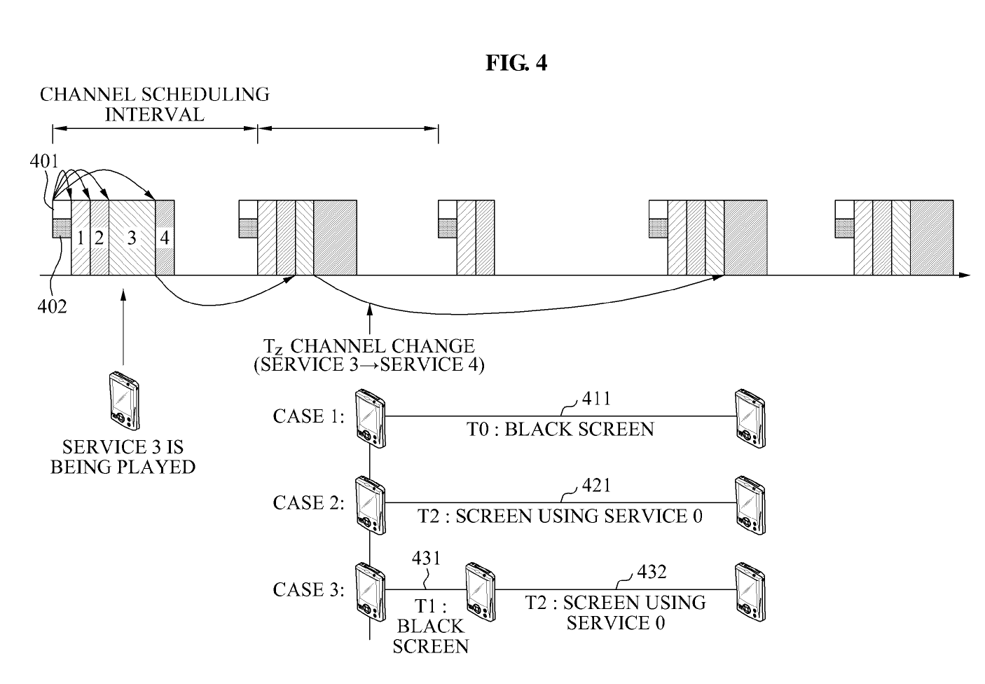

FIG. 4 is a diagram illustrating a process of providing abstract information when a channel change request is received according to another embodiment of the present invention.

FIG. 4 shows a case where a channel change occurs while providing a mobile TV service in a power saving structure. Referring to FIG. 4, service scheduling information may be included in a very front portion of each service interval. Scheduling information associated with each service may be included in an end portion of a previous service interval.

Every scheduling interval may include a scheduling block 401 containing the service scheduling information. “SERVICE 0” 402 that includes the abstract information and is provided in an independent channel form may be included after the scheduling block 401. Referring to FIG. 4, in a case where a terminal requests a channel change to view a channel for “SERVICE 4” at a point in time of Tz while viewing a channel for “SERVICE 3”, CASE 1 may provide a black screen during a channel zapping delay 411 according to a related art. In this case, all the frames may need to be retrieved during a period of time from when a channel zapping delay occurs to when a changed service is received. Accordingly, a power saving effect of the terminal may not be obtained, and a long channel zapping delay may be needed.

According to the present invention, in CASE 2, abstract information associated with the channel to be changed to may be extracted in advance at each channel scheduling interval and be provided using “SERVICE 0” during a period of time 421 from when the channel change request is received to when the channel change is completed.

According to the present invention, in CASE 3, in a case where abstract information is extracted when the channel change request is received, abstract information may be extracted in a subsequent channel scheduling interval and be provided during a period of time when the channel change request is received to when the channel change is completed. Specifically, a black screen may be provided during a period of time 431 from when the channel change request is received, to when “SERVICE 0” of a subsequent scheduling block is read. During a period of time 432 from when “SERVICE 0” is read, to when the channel change is completed, abstract information associated with the channel to be changed to may be provided using “SERVICE 0”. In this case, it is possible to maintain a power saving effect of a terminal, and to reduce a channel zapping delay.

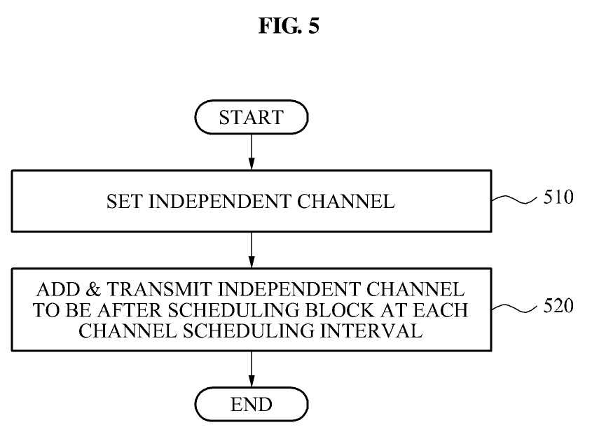

FIG. 5 is a flowchart illustrating a method of scheduling a radio access to reduce a channel zapping delay according to another embodiment of the present invention. FIG. 5 illustrates a method of providing abstract information from a transmission end to a terminal.

In operation 510, an independent channel containing abstract information with respect to all currently receivable channels may be set. For example, to provide the abstract information to the terminal, it is possible to set the independent channel that includes a text, an audio, a still cut, a moving picture, and the like with respect to all of the receivable channels. In addition to the independent channel, the abstract information may be transmitted in a form of an information field, or may be included in a scheduling block and thereby be transmitted.

In operation 520, the independent channel may be added to be after the scheduling block containing scheduling information associated with a plurality of channels, and thereby be transmitted at each channel scheduling interval. The independent channel may be fixed to be at an arbitrary location, instead of after the scheduling block, and thereby be transmitted.

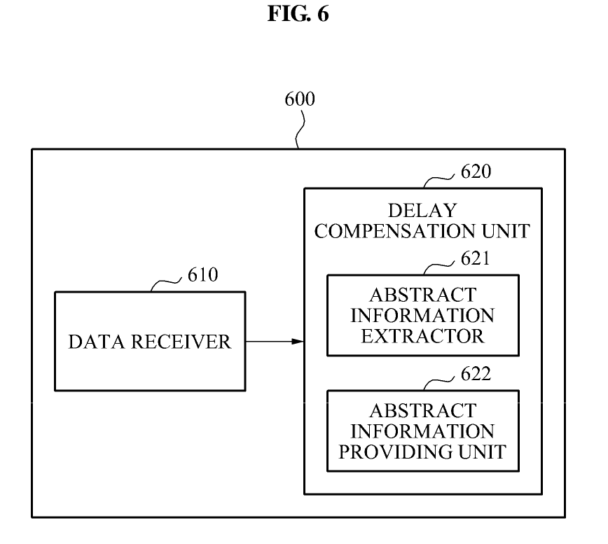

FIG. 6 is a block diagram illustrating an apparatus 600 for scheduling a radio access to reduce a channel zapping delay according to an embodiment of the present invention.

Referring to FIG. 6, the radio access scheduling apparatus 600 may include a data receiver 610 and a delay compensation unit 620

The data receiver 610 may receive abstract information with respect to all of receivable channels at each channel scheduling interval. The abstract information may be provided after a scheduling block containing scheduling information associated with a plurality of channels and be provided using an independent channel, or may be included in the scheduling block and thereby be provided. Also, the abstract information may be provided in an independent information field.

When a channel change request is received, the delay compensation unit 620 may provide information associated with a channel to be changed to using the abstract information during a channel zapping delay. Here, the received abstract information may be extracted together when the scheduling information associated with the plurality of channels is extracted. Also, the received abstract information may be extracted when the channel change request is received.

When the abstract information is provided in the independent information field, the delay compensation unit 620 may include an abstract information extractor 621 and an abstract information providing unit 622.

The abstract information extractor 621 may extract the abstract information by accessing an address of the information field. The abstract information providing unit 622 may provide information associated with the channel to be changed to using the extracted abstract information.

Matters not described with reference to FIG. 6 may refer to descriptions made above with reference to FIGS. 1 through 5.

As described above, abstract information with respect to all currently receivable channels may be received in advance and may be provided when a channel change request is received. Through this, it is possible to reduce a channel zapping delay.

Also, abstract information with respect to all currently receivable channels may be received. When a channel change request is received, the abstract information may be extracted and be provided. Through this, it is possible to maintain a power saving effect of a terminal, and to reduce a channel zapping delay.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of scheduling a radio access to reduce a channel zapping delay, the method comprising:
receiving abstract information with respect to all of receivable channels at each channel scheduling interval; and
providing information associated with a channel to be changed to using the abstract information during the channel zapping delay when a channel change request is received.

2. The method of claim 1, wherein the abstract information is provided after a scheduling block containing scheduling information associated with a plurality of channels and is provided using an independent channel, or is included in the scheduling block and is thereby provided.

3. The method of claim 1, wherein:
the abstract information is provided at a predetermined location using an independent channel, and
information associated with at least one of a size and a location of the independent channel is included in a scheduling block containing scheduling information associated with a plurality of channels that is included in a corresponding channel scheduling interval, and is thereby provided.

4. The method of claim 1, wherein:
the abstract information is provided within an independent information field, and
the providing comprises extracting the abstract information by accessing an address of the independent information field, and providing information associated with the channel to be changed to using the extracted abstract information.

5. The method of claim 1, wherein an amount of the channel zapping delay corresponds to an amount of time that is obtained by adding up an amount of time for searching for an I frame of the channel to be changed to and an amount of time used to receive service data of the channel to be changed to.

6. The method of claim 1, wherein the providing comprises extracting the received abstract information every time schedule information associated with a plurality of channels is extracted.

7. The method claim 1, wherein the providing comprises extracting the received abstract information when the channel change request is received.

8. The method of claim 1, wherein the abstract information includes at least one of a character, an audio, a picture, and a moving picture with respect to each of all the receivable channels.

9. A method of scheduling a radio access to reduce a channel zapping delay, the method comprising:
setting an independent channel containing abstract information with respect to all of receivable channels; and
adding the independent channel to be after a scheduling block containing scheduling information associated with a plurality of channels to transmit the scheduling information at each channel scheduling interval.

10. The method of claim 9, wherein the abstract information includes at least one of a character, an audio, a picture, and a moving picture with respect to each of all the receivable channels.

11. An apparatus for scheduling a radio access to reduce a channel zapping delay, the apparatus comprising:
a data receiver to receive abstract information with respect to all of receivable channels at each channel scheduling interval; and
a delay compensation unit to provide information associated with a channel to be changed to using the abstract information during the channel zapping delay when a channel change request is received.

12. The apparatus of claim 11, wherein the abstract information is provided after a scheduling block containing scheduling information associated with a plurality of channels and is provided using an independent channel, or is included in the scheduling block and is thereby provided.

13. The apparatus of claim 11, wherein:
the abstract information is provided at a predetermined location using an independent channel, and
information associated with at least one of a size and a location of the independent channel is included in a scheduling block containing scheduling information associated with a plurality of channels that is included in a corresponding channel scheduling interval, and is thereby provided.

14. The apparatus of claim 11, wherein:
the abstract information is provided within an independent information field, and
the delay compensation unit comprises:
an abstract information extractor to extract the abstract information by accessing an address of the independent information field; and
an abstract information providing unit to provide information associated with the channel to be changed to using the extracted abstract information.

15. The apparatus of claim 11, wherein an amount of the channel zapping delay corresponds to an amount of time that is obtained by adding up an amount of time for searching for an I frame of the channel to be changed to and an amount of time used to receive service data of the channel to be changed to.

16. The apparatus of claim 11, wherein the delay compensation unit comprises:
an abstract information extractor to extract the received abstract information every time schedule information associated with a plurality of channels is extracted.

17. The apparatus of claim 11, wherein the delay compensation unit comprises:
an abstract information extractor to extract the received abstract information when the channel change request is received.

18. The apparatus of claim 11, wherein the abstract information includes at least one of a character, an audio, a picture, and a moving picture with respect to each of all the receivable channels.
